(19) United States
(12) Patent Application Publication
(10) Pub. No.: US 2008/0160260 A1
(43) Pub. Date: Jul. 3, 2008

(54) Friction material for brakes

(76) Inventors: Norio Wada, Nagoya (JP); Hiroshi Kobayashi, Nagoya (JP); Hiroya Kishimoto, Aichi (JP)

Correspondence Address: BUCHANAN, INGERSOLL & ROONEY PC, POST OFFICE BOX 1404, ALEXANDRIA, VA, 22313-1404, US

(21) Appl. No.: 11/984,517

(22) Filed: Nov. 19, 2007

(30) Foreign Application Priority Data
Dec. 28, 2006 (JP) 2006-353922

(51) Int. Cl. B32B 5/30

(52) U.S. Cl. 428/148

(57) ABSTRACT

A friction material for brakes is formed by molding and hardening a raw material composition mainly containing a fibrous substrate, a friction adjuster, an organic filler, an inorganic filler and a binder in the form of a thermosetting resin. The friction material further contains aggregates of fine alumina particles, the aggregates having an average particle diameter of 30 to 60 μm, and the alumina particles having a particle diameter of 0.2 to 0.9 μm.

### CROSS REFERENCE TO RELATED APPLICATIONS

This application is based on and claims priority under 35 U.S.C. sctn. 119 with respect to Japanese Patent Application No. 2006-353922 filed on Dec. 28, 2006, the entire content of which is incorporated herein by reference.

### BACKGROUND OF THE INVENTION

This invention relates to a friction material for brake applications such as vehicle and industrial disk brakes and drum brakes, and particularly a friction material for brakes which is characterized by its low aggressiveness against the sliding surface of the mating member (i.e. lower tendency to damage the sliding surface), and its improved ability to clean the sliding surface (particularly its improved ability to remove rust on the sliding surface).

It is known to use hard inorganic particles having a large particle diameter, such as alumina particles or titanium particles, as an abrasive in a non-asbestos friction material for brakes to stably maintain a high friction coefficient. But hard inorganic particles having a large diameter (inorganic mono-crystalline particles) tend to show excessive aggressiveness not only against the mating member but against the friction material itself, thus increasing the possibility of squeaks (noise) and judder during braking.

To obviate this problem, it has been proposed to use alumina aggregates formed by aggregating mono-crystalline alumina particles as an abrasive, e.g. in JP patent publication 07-247372A (Patent document 1) and JP patent publication 10-205555A (Patent document 2).

It has also been proposed to wet-grind alumina aggregates to reduce their acute tips, thereby reducing their aggressiveness against mating surfaces, and simultaneously reduce the secondary particle diameter (particle diameter of the alumina aggregates) so as to be close to the primary particle diameter (particle diameter of the mono-crystalline alumina particles), thereby improving the dispersion properties of the secondary particles (alumina aggregates) in the friction material, and thus to stabilize its friction coefficient, e.g. in JP patent publication 2005-263823A (Patent document 3).

The primary and secondary particle diameters of alumina aggregates disclosed in Patent documents 1 to 3 and their contents are as follows:

Patent document 1: Primary particle diameter=0.4 μm, Secondary particle diameter=about 5 μm to about 200 μm (maximum distribution being 63 μm), and Content=0.5 to 20% by volume

Patent document 2: Average primary particle diameter=1 to 10 μm, Average secondary particle diameter=30 to 100 μm, and Content=0.1 to 2%

Patent document 3: Average primary particle diameter=1.0 to 5.0 μm, Average particle diameter of ground alumina aggregates=1.0 to 15.0 μm, and Content=0.1 to 1.0% by volume

By using alumina aggregates as an abrasive, while it is possible to reduce the aggressiveness against mating surfaces, the ability to clean the mating member, especially the ability to remove rust tends to decrease.

In this regard, among the friction materials disclosed in Patent documents 1 to 3, there are none that are both sufficiently low in aggressiveness against mating surfaces and sufficiently high in the ability to remove rust on mating members. For example, the friction material disclosed in Patent document 3 is not sufficiently high in the ability to remove rust because the average particle diameter of the ground alumina aggregates is 15 μm or less.

The friction material disclosed in Patent document 1 tends to be either low in the ability to remove rust (on the mating member) or high in aggressiveness against the mating surface. Thus, it is not sufficiently reliable to use. The friction material of Patent document 2 is too high in aggressiveness against the mating surface.

### SUMMARY OF THE INVENTION

An object of the present invention is to provide a friction material which is sufficiently low in aggressiveness against mating surfaces and simultaneously sufficiently high in the ability to remove rust, while keeping a high and stable friction coefficient.

In order to achieve this object, the present invention provides a friction material for brakes formed by molding and hardening a raw material composition mainly comprising a fibrous substrate, a friction adjuster, an organic filler, an inorganic filler and a binder comprising a thermosetting resin, the friction material containing aggregates of fine alumina particles, the aggregates having an average particle diameter of 30 to 60 μm, and the alumina particles having a particle diameter of 0.2 to 0.9 μm.

The content of the alumina aggregates is preferably in the range of 0.1 to 4.0% by volume.

The fine alumina particles having a particle diameter of 0.2 to 0.9 μm and forming the alumina aggregates are α-alumina particles. Such alumina is produced by calcining aluminum hydroxide. By increasing the calcining temperature, α-alumina is produced ultimately. α-alumina has a melting point of 2050° C. and a Mohs hardness (new Mohs hardness) of 12. It is not only high in hardness but has other superior properties, including high chemical stability, high melting point and high mechanical strength.

By using fine alumina having a particle diameter of 0.2 to 0.9 μm as primary particles for the friction material according to the present invention, it is possible to maintain a high friction coefficient while suppressing aggressiveness against mating surfaces. By determining the average particle diameter of the secondary particles (alumina aggregates) in the range of 30 to 60 μm, the friction material of the present invention has also a sufficiently high ability to remove rust. Thus, the friction material according to the present invention is sufficiently low in aggressiveness against both the mating surface and the friction material itself, and simultaneously sufficiently high in the ability to remove rust, while maintaining a high friction coefficient. Even if alumina aggregates are partially ground, because alumina that separates from the friction material as a result is fine alumina particles, it is low in aggressiveness against the friction material itself.

If the particle diameter of the primary particles is less than 0.2 μm, the ability of the friction material to remove rust tends to be insufficient. If the particle diameter of the primary particles is larger than 0.9 μm, the aggressiveness of the friction material against mating surfaces tend to be too high. Thus, the particle diameter of the primary particles has to be in the range of 0.2 to 0.9 μm.

If the average particle diameter of the alumina aggregates are less than 30 μm, the friction material tends to be low in the ability to remove rust. If their average particle diameter is larger than 60 μm, the dispersibility of the alumina aggregates tends to be low, which can destroy uniformity in the ability to remove rust over the entire mating surface. Thus, the average particle diameter of the alumina aggregates has to be in the range of 30 to 60 μm.

The content of the alumina aggregates is preferably in the range of 0.1 to 4.0% by volume. As will be apparent from the later examples, if the content of the alumina aggregates is less than 0.1% by volume, the effect of the addition of the alumina aggregates tends to be insufficient. If their content is higher than 4.0% by volume, the friction material tends to show excessive aggressiveness against the mating surface.

### DETAILED DESCRIPTION OF THE PREFERRED EMBODIMENTS

The friction material embodying the present invention is now described. The friction material according to the invention includes a fibrous substrate selected from organic fibers such as aramid fibers, inorganic fibers such as rock wool, metallic fibers such as copper fiber. Asbestos, which is known to be hazardous, is not used. The friction material further contains cashew dust, potassium titanate, graphite, barium sulfate, calcium hydroxide and/or zirconium oxide as friction adjusters and fillers.

The friction material also contains aggregates of fine alumina particles, i.e. aggregated alumina, as an abrasive that also serves as a friction adjuster. The alumina aggregates comprise aggregates of fine alumina particles having diameters in the range of 0.2 to 0.9 μm. The aggregates have an average particle diameter of 30 to 60 μm. The content of the alumina aggregates is preferably limited to 0.1 to 4.0% by volume.

These raw materials are bound together by a binder comprising a thermosetting resin. The thermosetting resin used is preferably one that is superior in heat resistance, flame resistance and mechanical properties. Phenolic resin is one of the resins that meets all these requirements.

The friction material according to the present invention is obtained by molding a raw mixture of the above-mentioned necessary raw materials in a predetermined ratio while applying predetermined temperature and pressure thereto, thermosetting the binder resin, and optionally finish-grinding the thus molded composition resin, into a desired end product such as a friction pad. Molding and thermosetting may be carried out by ordinary methods as disclosed in the abovementioned Patent documents 2 and 3 or other methods ordinarily used in forming conventional friction materials. Manufacturing conditions are also not particularly limited, and ordinarily and conventionally used manufacturing conditions may be selected.

### EXAMPLES

For performance evaluation, friction material specimens containing alumina aggregates were prepared. Table 1 shows the relationship between the particle diameters of fine alumina particles forming the alumina aggregates added to the respective specimens (primary particle diameters) and the particle diameters of the alumina aggregates (secondary particle diameters). Table 2 shows the raw materials forming the respective specimens and their contents. Table 2 also shows the results of tests for friction performance, aggressiveness against rotors (mating surfaces), and ability to remove rust, conducted for the respective specimens, as well as evaluation of dispersion properties of alumina aggregates contained in the respective specimens. Examples 1-13 in Table 2 are examples according to the present invention. The details of these performance evaluation tests and the standards of evaluation are summarized below.

### [Friction Performance Test]

A full-size dynamometer test under JASO C406 was conducted.

Standards of evaluation (Secondary effect): Friction coefficients μ were determined at speed Vo=100 km/h and deceleration=0.6 G. In Table 2, the symbols ◯ and × mean as follows:

◯: 0.37<μ, ×: μ<0.37

### [Test for Aggressiveness Against Rotors]

A test for aggressiveness against rotors under JIS D 4411 was conducted.

Standards of evaluation: The amounts of wear of the mating rotors were determined after pressing the respective friction material specimens against rotors for 20 hours under pressure of 0.05 kgf/cm² and at the revolving speed corresponding to the vehicle speed of 100 km/h. In Table 2, the symbols ◯ and × mean as follows:

◯: Rotor wear amount ≦10 μm, ×: 10 μm<Rotor wear amount

### [Test for the Ability to Remove Rust]

The ability to remove rust was tested using a full-size dynamometer under in-house evaluation standards determined by the applicant.

Standards of evaluation: The respective friction material specimens were brought 200 times into frictional contact with rusted rotors prepared for the test by keeping them in a humid box kept at a temperature of 50° C. and a humidity of 95%, with the revolving speed of the rotors kept at V=60 km/h at a deceleration of 0.4 G, and the rust removal rate was calculated from the thicknesses of rust on each rotor before and after the test. In Table 2, the symbols ◯ and × mean as follows:

◯: 80% ≦Rust removal rate, ×: Rust removal rate <80%

Rust removal rate (%)=(Thickness of rust before the test−Thickness of rust after the test)×100/Thickness of rust before the test

### [Dispersion Properties]

In the evaluation of the ability to remove rust, the influence of the dispersion properties on the ability to remove rust was tested.

Standards of evaluation: After the respective friction material specimens had been brought 200 times into frictional contact with rusted rotors prepared for the test by keeping them in a humid box kept at a temperature of 50° C. and a humidity of 95%, with the revolving speed of the rotors kept at V=60 km/h at a deceleration of 0.4 G, the area rate (%) of the rust remaining on each rotor was calculated. In Table 2, the symbols ◯ and × mean as follows:

◯: Area rate of the remaining rust ≦20%, ×: 20%<Area rate of the remaining rust

—Evaluation—

As will be apparent from the test results shown in Table 2, Comparative Example 1 is inferior in friction performance. This is presumably because the primary particle diameter of alumna used is too small. Comparative Example 2 is high in aggressiveness against rotors (mating surfaces). This is presumably because the primary particle diameter of alumina is too large. Comparative Example 3 is inferior in the ability to remove rust, and Comparative Example 4 is inferior in dispersion properties, presumably because in Comparative Example 3, the particle diameter of the alumina aggregates (secondary particle diameter) is too small and conversely in Comparative Example 4, the secondary particle diameter is too large.

In contrast, in any of Examples 1 to 7 and 9-12, the symbol ◯ is given in every evaluation item. Example 8 is inferior in friction performance, while Example 13 is high in aggressiveness against rotors. Considering the test data, this is presumably because the contents of the alumina aggregates in Examples 8 and 13 are too low and too high, respectively.

TABLE 1

| | |
|---|---|
| | Particle diameter of fine |
| | alumina particles (primary |
| Alumina particle | particle diameter) (μm) |

| diameter | | 0.1 | 0.2 | 0.4 | 0.6 | 0.9 | 1.2 |
|---|---|---|---|---|---|---|---|
| Average particle | 15 | | | G | | | |
| diameter of | 30 | | | H | | | |
| alumina | 42 | A | B | C | D | E | F |
| aggregates | 53 | | | I | | | |
| (secondary | 60 | | | J | | | |
| particle | 66 | | | K | | | |
| diameter)(μm) | | | | | | | |

TABLE 2

| | | Content (volume %) | | | | | | | | |
|---|---|---|---|---|---|---|---|---|---|---|
| | | Comparative | | | | | Comparative | Comparative | | |
| Raw material | | Example 1 | Example 1 | Example 2 | Example 3 | Example 4 | Example 2 | Example 3 | Example 5 | Example 6 |
| Phenolic resin | | 18 | 18 | 18 | 18 | 18 | 18 | 18 | 18 | 18 |
| Cashew dust | | 10 | 10 | 10 | 10 | 10 | 10 | 10 | 10 | 10 |
| Organic fiber | | 10 | 10 | 10 | 10 | 10 | 10 | 10 | 10 | 10 |
| Inorganic fiber | | 7 | 7 | 7 | 7 | 7 | 7 | 7 | 7 | 7 |
| Metallic fiber | | 5 | 5 | 5 | 5 | 5 | 5 | 5 | 5 | 5 |
| Potassium titanate | | 10 | 10 | 10 | 10 | 10 | 10 | 10 | 10 | 10 |
| Graphite | | 6 | 6 | 6 | 6 | 6 | 6 | 6 | 6 | 6 |
| Barium sulfate | | 26 | 26 | 26 | 26 | 26 | 26 | 26 | 26 | 26 |
| Calcium hydroxide | | 2 | 2 | 2 | 2 | 2 | 2 | 2 | 2 | 2 |
| Zirconium oxide | | 4 | 4 | 4 | 4 | 4 | 4 | 4 | 4 | 4 |
| Alumina | A | 2.0 | | | | | | | | |
| | B | | 2.0 | | | | | | | |
| | C | | | 2.0 | | | | | | |
| | D | | | | 2.0 | | | | | |
| | E | | | | | 2.0 | | | | |
| | F | | | | | | 2.0 | | | |
| | G | | | | | | | 2.0 | | |
| | H | | | | | | | | 2.0 | |
| | I | | | | | | | | | 2.0 |
| | J | | | | | | | | | |
| | K | | | | | | | | | |
| Total | | 100 | 100 | 100 | 100 | 100 | 100 | 100 | 100 | 100 |
| Friction | Second | 0.33 | 0.38 | 0.41 | 0.42 | 0.43 | 0.41 | 0.41 | 0.41 | 0.42 |
| performance | effectμ | | | | | | | | | |
| test | [—] Vo = 100 km/h | | | | | | | | | |
| | Evaluation | X | ◯ | ◯ | ◯ | ◯ | ◯ | ◯ | ◯ | ◯ |

| | | | | | | | | | |
|---|---|---|---|---|---|---|---|---|---|
| Evaluation of | ◯ | ◯ | ◯ | ◯ | ◯ | X | ◯ | ◯ | ◯ |
| aggressiveness | | | | | | | | | |
| against rotors | | | | | | | | | |
| Evaluation of ability | ◯ | ◯ | ◯ | ◯ | ◯ | ◯ | X | ◯ | ◯ |
| to remove rust | | | | | | | | | |
| Dispersion | ◯ | ◯ | ◯ | ◯ | ◯ | ◯ | ◯ | ◯ | ◯ |
| properties | | | | | | | | | |

| | | Content (volume %) | | | | | | | |
|---|---|---|---|---|---|---|---|---|---|
| | | | Comparative | | | Example | Example | Example | Example |
| Raw material | | Example 7 | Example 4 | Example 8 | Example 9 | 10 | 11 | 12 | 13 |
| Phenolic resin | | 18 | 18 | 18 | 18 | 18 | 18 | 18 | 18 |
| Cashew dust | | 10 | 10 | 10 | 10 | 10 | 10 | 10 | 10 |
| Organic fiber | | 10 | 10 | 10 | 10 | 10 | 10 | 10 | 10 |
| Inorganic fiber | | 7 | 7 | 7 | 7 | 7 | 7 | 7 | 7 |
| Metallic fiber | | 5 | 5 | 5 | 5 | 5 | 5 | 5 | 5 |
| Potassium titanate | | 10 | 10 | 10 | 10 | 10 | 10 | 10 | 10 |
| Graphite | | 6 | 6 | 6 | 6 | 6 | 6 | 6 | 6 |
| Barium sulfate | | 26 | 26 | 27.95 | 27.9 | 27 | 25 | 24 | 23.5 |
| Calcium hydroxide | | 2 | 2 | 2 | 2 | 2 | 2 | 2 | 2 |
| Zirconium oxide | | 4 | 4 | 4 | 4 | 4 | 4 | 4 | 4 |
| Alumina | A | | | | | | | | |
| | B | | | | | | | | |
| | C | | | 0.05 | 0.1 | 1.0 | 3.0 | 4.0 | 4.5 |
| | D | | | | | | | | |
| | E | | | | | | | | |
| | F | | | | | | | | |
| | G | | | | | | | | |
| | H | | | | | | | | |
| | I | | | | | | | | |
| | J | 2.0 | | | | | | | |
| | K | | 2.0 | | | | | | |
| Total | | 100 | 100 | 100 | 100 | 100 | 100 | 100 | 100 |
| Friction | Second | 0.41 | 0.40 | 0.34 | 0.38 | 0.40 | 0.41 | 0.41 | 0.40 |
| performance | effectμ | | | | | | | | |
| test | [—] Vo = 100 km/h | | | | | | | | |
| | Evaluation | ◯ | ◯ | X | ◯ | ◯ | ◯ | ◯ | ◯ |

| | | | | | | | | |
|---|---|---|---|---|---|---|---|---|
| Evaluation of | ◯ | ◯ | ◯ | ◯ | ◯ | ◯ | ◯ | X |
| aggressiveness | | | | | | | | |
| against rotors | | | | | | | | |
| Evaluation of ability | ◯ | ◯ | ◯ | ◯ | ◯ | ◯ | ◯ | ◯ |
| to remove rust | | | | | | | | |
| Dispersion | ◯ | X | ◯ | ◯ | ◯ | ◯ | ◯ | ◯ |
| properties | | | | | | | | |

What is claimed is:

1. A friction material for brakes formed by molding and hardening a raw material composition mainly comprising a fibrous substrate, a friction adjuster, an organic filler, an inorganic filler, and a binder comprising a thermosetting resin, said friction material containing aggregates of fine α-alumina particles, said aggregates having an average particle diameter of 30 to 60 μm, and said α-alumina particles having a particle diameter of 0.2 to 0.9 μm.

2. The friction material for brakes of claim 1 wherein the content of said aggregates is 0.1 to 4.0% by volume.
